(19) United States
(12) Patent Application Publication
(10) Pub. No.: US 2008/0210866 A1
(43) Pub. Date: Sep. 4, 2008

(54) Motioning Equipment for Electron Column

(75) Inventors: Ho Seob Kim, Chonan-si (KR); Byeng Jin Kim, Incheon (KR)

Correspondence Address: PARK LAW FIRM, 3255 WILSHIRE BLVD, SUITE 1110, LOS ANGELES, CA, 90010, US

(73) Assignee: CEBT Co. Ltd., Asan-si, Chungcheongnam-do (KR)

(21) Appl. No.: 11/792,274

(22) PCT Filed: Sep. 1, 2005
(86) PCT No.: PCT/KR05/02905

§ 371 Date: Jun. 1, 2007

(30) Foreign Application Priority Data
Sep. 1, 2004 (KR) 10-2004-0069732

(51) Int. Cl. G01N 23/00

(52) U.S. Cl. 250/310

(57) ABSTRACT

Provided is motioning equipment which provides relative motion between electron column emitting electron beam and a sample on which the electron beam is irradiated. The motioning equipment includes multi-microcolumn for emitting electron beams on the sample, supports for supporting the multi-microcolumns, and driving means for driving the supports to move the multi-microcolumns.

### TECHNICAL FIELD

The present invention relates to a motioning equipment for an electron column, and more particularly, to motioning equipment for electron columns for controlling movement of the electron columns emitting electron beams, in order to utilize the electron columns effectively.

### BACKGROUND ART

Conventionally, because of a very large size, a device for emitting electron beam is mainly used in stationary structures such as a cathode ray tube (CRT), an electron microscope, and so on. In particular, in the case of the electron microscope, it is necessary to move a sample when being used, because the device for emitting electron beam has a very large size. Thus, it is very inconvenient to use the electron microscope for the purpose of scanning a surface area of the sample having a very large size.

Owing to an effort to downsize the electron beam emitter, a microcolumn has been developed as a small-size electron column, and preferably as a miniature electron column. Generally, the microcolumn emits the electron beams in a vacuum state according to the same principle as that of the CRT or electron microscope. To this end, the microcolumn has an electron emitter, a source lens, a deflector and a focusing lens. However, no practical method for utilizing the downsized electron column has been yet provided.

### DISCLOSURE OF INVENTION

### Technical Problem

It is an objective of the present invention to provide motioning equipment for electron columns capable of minimizing movement of a sample and decreasing a size by means of motioning of the electron columns compared to the conventional motioning equipment.

It is another objective of the present invention to provide motioning equipment for electron columns capable of providing a temporal advantage using the electron columns in a multiple and movable way to scan a plurality of unit surface areas through a plurality of electron beams for a shot time.

### Technical Solution

Motioning equipment for electron column according to the present invention comprises:

the electron column for emitting electron beam on a sample;

chamber for receiving the electron column and maintaining the electron column in an ultra-high vacuum;

support for supporting the chamber;

driving means for driving the support to move the electron column in real time;

the sample on which the electron beam emitted from the electron column is irradiated; and

a vacuum chamber for maintaining the sample in a low or high vacuum.

The electron columns used in the motioning equipment of the present invention employ the same principle as in CRT (Cathode Ray Tube) or electron microscope. As a typical microscopic electron column, a microcolumn is used. Generally, the microcolumn is composed of an electron emitter, a source lens, a deflector, and a focus lens, and emits the electron beam in a vacuum. In the case of the microcolumns used in the present invention, the elements such as the deflector may be modified according to a use. For instance, if deflecting is not required, the deflector is not used. If focusing is not important, the focusing may be simply carried out or omitted.

The motioning equipment of the present invention is for utilizing an advantage that the electron column has a small size. Here, the total apparatus is made smaller in size due to the motioning equipment of the present invention to allow relative motion between the sample on which the electron beam emitted from the electron column is irradiated and the electron column. Further, when a plurality of electron beams are designed to be irradiated on the whole surface area of the sample using multi-microcolumns, it is possible to shorten a time for complete inspection and measurement without making the whole size of the apparatus bigger.

The motioning equipment of the present invention should be used in a vacuum state in view of a characteristic of the electron column. Further, a vacuum should be maintained such that the electron beam emitted from the electron column can effectively reach the sample. To this end, it is necessary that the motioning equipment is used in a vacuum chamber. However, maintaining the whole vacuum chamber in an ultra-high vacuum in order to use the microcolumns is very expensive. In general, a (working) distance between a microcolumn and the sample on which the electron beam is irradiated has a range of 1 to 400 mm, and is for the most part short. Thus, in the motioning equipment of the present invention, it is more preferable that the vacuum chamber maintains a high or low vacuum of, for example, about 10⁻⁷ torr or less on the whole, and that each microcolumn and the periphery of the sample near to the microcolumn maintain an ultra-high vacuum of, for example, 10⁻⁷ to 10⁻¹¹ torr, and preferably 10⁻⁹ torr or more. To this end, a separate chamber is provided for the microcolumn and is maintained in an ultra-high vacuum (10⁻⁷ to 10⁻¹¹ torr) using an ion pump etc. Each of the chambers for the microcolumn is provided with an aperture to allow the electron beam emitted through the final aperture of an Einzel or focus lens to reach the sample. Thereby, the electron beams can be effectively transmitted to the sample in the high vacuum region. If it is difficult to maintain in ultra high vacuum in the chamber for an electron column due to the difference of the degrees of vacuum between the chamber for an electron column and the vacuum chamber and the electron beam is not effectively emitted and irradiated, the aperture of the chamber for an electron column through which the electron beam travels may be decreased in size in order to little more increase the degree of vacuum of the chamber for an electron column or maintain a high degree of vacuum in the chamber for a little longer time. This is intended to use the electron column with the degree of vacuum differentiated by separating the chamber for the electron column from the vacuum chamber for the sample. The lens aperture of each electron column may serve as the aperture of each chamber in order to make the structure of the motioning equipment simpler if necessary.

### Advantageous Effects

The motioning equipment for an electron column according to the present invention can be used in a patterning apparatus to record very highly precise and dense information by replacing a laser or optical instrument, for example, in a writing apparatus for a high density of compact disk (CD) or digital video disk (DVD) having a capacity of 25 gigabits or more, or in an apparatus for inspecting and/or measuring CD, DVD, and etc. Further, the motioning equipment for electron columns according to the present invention can make a lithographic print in a more rapid and precise way in conventional lithography, and solve a spatial-temporal problem in various fields of utilizing the electron beam, such as inspection and/or measurement, analysis, and/or repair apparatuses and so on.

### BRIEF DESCRIPTION OF THE DRAWINGS

FIG. 1 is a schematic perspective view of a first embodiment for providing motion to multiple electron columns in accordance with the present invention.

FIG. 2 is a schematic perspective view of a second embodiment for providing motion to multiple electron columns in accordance with the present invention.

FIG. 3 is a schematic perspective view of an example of controlling motion of each of multiple electron columns in accordance with the present invention.

FIG. 4 is a cross-sectional view of another example of controlling motion of each of multiple electron columns in accordance with the present invention.

FIG. 5 is a cross-sectional view of yet another example of controlling motion of each of multiple electron columns in accordance with the present invention.

FIG. 6 is a cross-sectional view of an example of controlling another motion of each of multiple electron columns of FIG. 4.

### BEST MODE FOR CARRYING OUT THE INVENTION

Hereinafter, motioning equipment for electron columns according to an exemplary embodiment of the present invention will be described in detail with reference to the attached drawings.

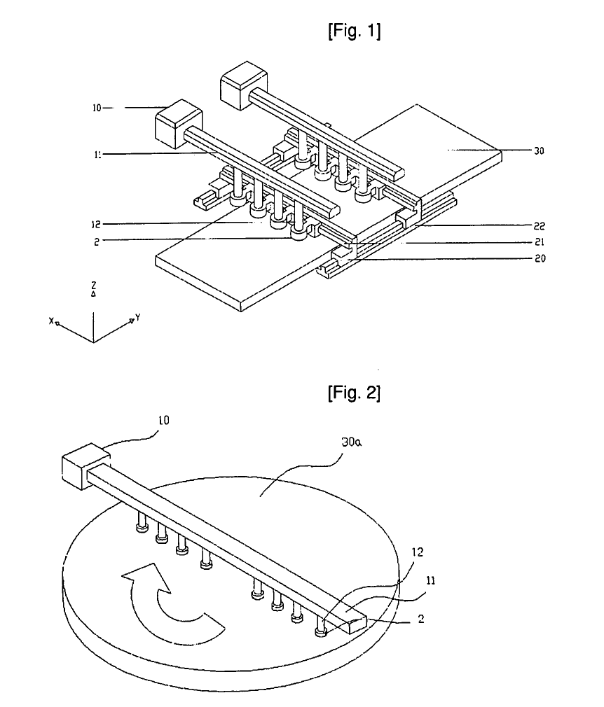

FIG. 1 is a perspective view schematically of a first embodiment of motioning equipment of multi-microcolumns, as multiple electron columns, according to the present invention. Here, the motioning equipment is operated in a vacuum chamber due to a characteristic of the microcolumn, wherein the vacuum chamber is not shown. The first embodiment where the motioning equipment is used in the vacuum chamber is shown.

In FIG. 1, eight microclumns (not shown) are inserted into or attached to supports 2 and coupled to two x-axial shafts 11, in which four microcolumns are allocated to one x-axial shaft 11 through connectors 12, respectively. The x-axial shafts 11 cause the microcolumns to perform linear motion by means of drive members 10. In the present embodiment, the microcolumns are inserted into or attached to the supports 2, respectively. Further, the supports 2 are coupled to shafts 21 of supporting members 20. When the supporting members 20 perform linear motion along y-axial shafts 22 by means of separate driving devices, they can linearly move in a direction perpendicular to the shafts 11 (y-axial direction). The microcolumns may perform more diverse motion when performing vertical motion or free tilting motion at an arbitrary angle in real time with respect to the connectors 12. For the motion of the microcolumns, there may be used various methods, for example, of mounting linear motion or tilting means in order to vertically move the microcolumns with respect to the connectors 12.

A sample 30 is transferred by a separate driving means to allow electron beams emitted from each microcolumn to be irradiated thereon.

In the present embodiment, in order to mount each microcolumn in the chamber to maintain an ultra-high vacuum, the supports 2 could be formed into vacuum chambers and have a separate vacuum wiring or piping, and then the chambers in which the microcolumns are received can be maintained in the ultra-high vacuum using an ion or getter pump. In this case, electric and vacuum wirings may be carried out in the same method as those used in an existing x-y robot or arm robot. If the microcolumns are freely tilted, the connectors 12 are preferably coupled in a bellows type to the supports 2 acting as the chambers. Further, the supports 2 may be directly connected with small-size ion pumps, thereby formed into the vacuum chambers for the microcolumns.

### Mode for the Invention

FIG. 2 is a schematic perspective view of a second embodiment for providing motion to multiple electron columns in accordance with the present invention. Unlike the first embodiment of FIG. 1, a sample rotates, and microcolumns move linearly.

In FIG. 2, four microclumns (not shown) are inserted into or attached to supports 2 and coupled to a driving shaft 11. In the second embodiment, the microcolumns move linearly by means of drive member 10. A sample 30a rotates by means of a separate driving means (not shown). This driving means for driving the sample is preferably located under the sample. The driving shaft 11 preferably causes the microcolumns to linearly move between the center of rotation and an outer circumferential edge of the sample 30a.

Of course, in the second embodiment, a method for placing each microcolumn in the chamber and separately maintaining a ultra high vacuum is the same as described in the first embodiment of FIG. 1.

Further, the microcolumns have the same tilting motion mode as that described in the first embodiment of FIG. 1.

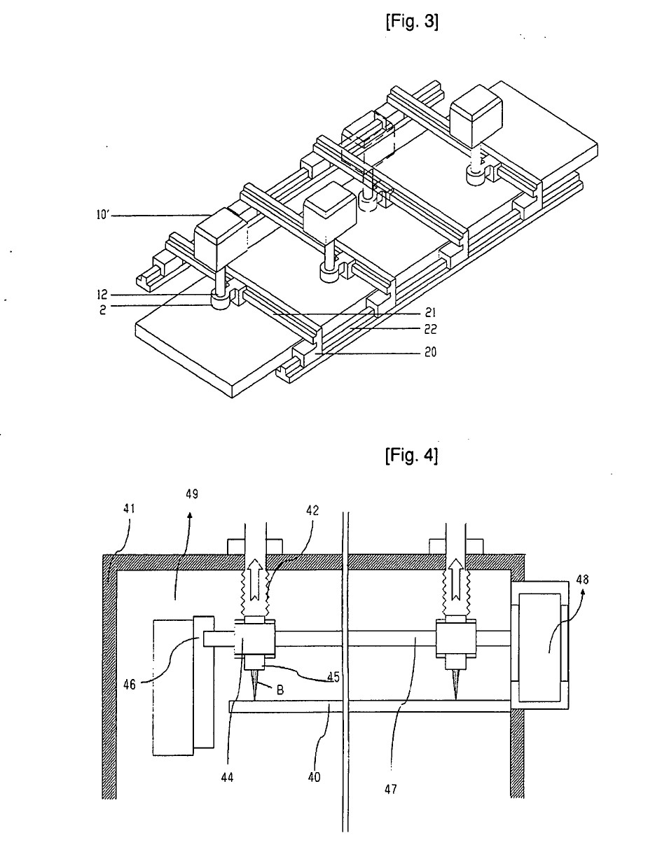

FIG. 3 is a schematic perspective view of another motioning equipment for providing motion to microcolumns of the present invention. Unlike the first embodiment of FIG. 1, this embodiment is characterized in that motion of each microcolumn takes place individually. It is different from the first embodiment of FIG. 1 in that drive members 10 causes supports 2 to perform z-axial motion or tilting, and that x-y motion is generated by a separate driving device (not shown). The others are the same as in FIG. 1. In this case, if the microcolumns are tilted, the connectors 12 are preferably coupled in a bellows type to the supports 2 acting as chambers, respectively.

FIG. 4 shows another example of motioning equipment having microcolumns of the present invention. In FIG. 4, a vacuum chamber 49 is isolated from the outside by a wall 41, and maintains a vacuum (10⁻² to 10⁻⁶ torr). A chamber 45 for each microcolumn maintains an ultra-high vacuum (10⁻⁷ to 10⁻¹¹ torr) by aid of a flexible tube such as a bellows 42 and is different from the vacuum chamber in which a high or low vacuum is maintained. The chamber 45 for each microcolumn is coupled with an ion pump (not shown) through the bellows 42 and maintains the ultra-high vacuum unlike the low vacuum of the vacuum chamber. Further, the chamber 45 for each microcolumn is attached or coupled to a holder 44 and transferred by shafts 46 and 47. Unlike existing electron beam generators, each microcolumn is small in size and convenient in motion, so that it can perform motion using the bellows etc. with ease. The chamber 45 for each microcolumn is formed with an aperture having a diameter of about 1 to 3 mm so that the electron beam can be irradiated. However, this size of aperture allows a degree of vacuum between the chamber 45 for each microcolumn and the vacuum chamber 49 to be maintained individually. Further, the size of the aperture through which the electron beam can reach and scan a sample may be varied at need, for example depending on a design of the pump, such as the ion pump, which can make and maintain the ultra-high vacuum in the chamber for each microcolumn. The main reason why the chamber 45 for each microcolumn is separately provided using the flexible tube, such as bellows, is that the ultra-high vacuum in the chamber 45 could be made not only by directly installing the ion pump etc. to the chamber 45 but through the bellows 42. The equipment, such as the pump, for making the ultra-high vacuum is large in size as well as unfavorable during motion because the chamber 45 itself is increased in size. Further, use of the bellows makes it possible to easily repair and/or replace any microcolumn with the vacuum of the entire vacuum chamber maintained without any change when any microcolumn is repaired or replaced. Each microcolumn may be repaired and/or replaced in a separate exchange room 48. To this end, the microcolumn is sent to the exchange room 48 using the shaft 47. The exchange room 48 is provided with a transfer apparatus or an apparatus such as a load lock, or constructed to transfer the microcolumn using the internal shaft etc. And the exchange room 48 can repair and/or replace the microcolumn without changing the degree of vacuum in the vacuum chamber using a gate valve etc.

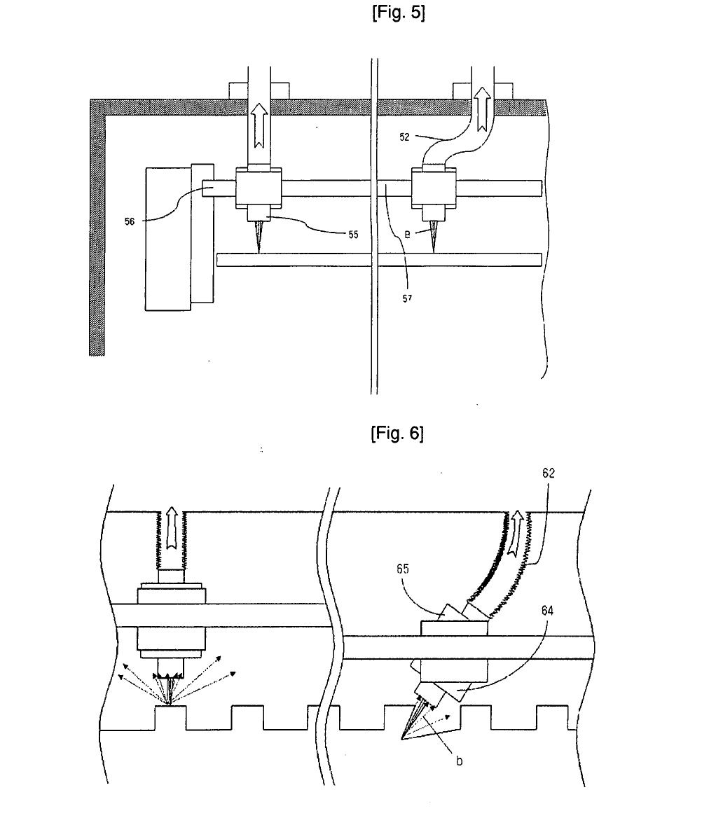

FIG. 5 shows another example where the motioning equipment of FIG. 4 is used, in which any one of microcolumns is displaced by movement of a flexible tube 52 so as to irradiate an electron beam on another position of a sample. In FIG. 5, a chamber 55 for a right-side microcolumn is transferred in an x-y direction by shafts 56 and 57. At this time, the flexible tube 52 is bent readily to enable the chamber 55 for the right-side microcolumn to continue to maintain an ultra-high vacuum.

FIG. 6 shows yet another example where motioning equipment of FIG. 4 is used, in which any one of microcolumns is tilted by movement of a flexible bellows tube 62. When a sample is inspected by the microcolumn, the microcolumn is tilted in order to precisely inspect a problematic portion of the sample, and then an electron beam of the microcolumn is irradiated on the problematic portion of the sample. In FIG. 6, as a holder 64 rotates about a shaft, a chamber 65 for the microcolumn is tilted. In other words, the microcolumn of the chamber 65 is tilted at a predetermined angle, and thereby the sample is scanned at a predetermined angle rather than a right angle. Thus, electrons emitted from the microcolumn collide with the sample, and then other electrons b backscattered or ejected from the sample after collision are directed toward the chamber for the microcolumn.

The flexible type described in FIGS. 4 to 6 could be used in the embodiments of FIGS. 1 to 3. In particular, when the sample rotates like a disk as in FIG. 2 and the entire apparatus should be decreased in size, it is preferable to use the flexible tube.

In the present invention, the microcolumn is used as a single type and independently inserted into the supports 2 respectively, but it may be used as a multiple type. The multi-microcolumns may be used by combination of a plurality of single microcolumns or as various types of multi-microcolumns such as a wafer type of multi-microcolumn produced in a semiconductor process.

The number of microcolumns described in the present invention, four or eight, is for the illustrative purpose. Thus, the number and arrangement of microcolumns may be variously varied at need.

### INDUSTRIAL APPLICABILITY

The motioning equipment for electron columns according to the present invention can be used for inspection, measurement and/or repair equipment using the electron beams.

Further, the motioning equipment is adapted to be used in various fields by motion of the microscopic multi-microcolumns, and more particularly to use the electron beams for semiconductor lithography, for measurement, inspection and analysis apparatuses such as the electron microscope, or for recording and inspection of data in a recording medium such as a high density of CD or DVD.

1. Motioning equipment for electron column comprising:
the electron column for emitting electron beam on a sample;
a chamber for receiving the electron column and maintaining the electron column in an ultra-high vacuum;
a support for supporting the chamber;
a driving means for driving the support to move the electron column in real time;
the sample on which the electron beam emitted from the electron column is irradiated; and
a vacuum chamber for maintaining the sample in a low or high vacuum.

2. The motioning equipment according to claim 1, wherein the support is further attached with means for providing at least one of vertical motion and tilting to each microcolumn in real time.

3. The motioning equipment according to claim 1, further comprising a rotating plate for rotating the sample.

4. The motioning equipment according to claim 1, wherein the chamber is coupled to an external pumping apparatus through flexible tubes to maintain an ultra-high vacuum.

5. The motioning equipment according to claim 2, further comprising a rotating plate for rotating the sample.

6. The motioning equipment according to claim 2, wherein the chamber is coupled to an external pumping apparatus through flexible tubes to maintain an ultra-high vacuum.
